(19) United States
(12) Patent Application Publication
(10) Pub. No.: US 2021/0312143 A1
(43) Pub. Date: Oct. 7, 2021

(54) REAL-TIME CALL TRANSLATION SYSTEM AND METHOD

(71) Applicant: Smoothweb Technologies Limited, Sheung Wan (HK)

(72) Inventor: RAJIV TREHAN, LONDON (GB)

(73) Assignee: Smoothweb Technologies Limited, Sheung Wan (HK)

(21) Appl. No.: 17/218,717

(22) Filed: Mar. 31, 2021

Related U.S. Application Data
(60) Provisional application No. 63/003,851, filed on Apr. 1, 2020.

(51) Int. Cl. G06F 40/58; G10L 15/26; H04M 3/42

(52) U.S. Cl. CPC G06F 40/58; G10L 15/26; H04M 2242/12; H04M 2203/2061; H04M 3/42

(57) ABSTRACT

A real-time call translation system and method is provided. The invention provides establishing a voice call between a user speaking a source language and another user understanding and speaking a different target language; and performing translation of the audio of the source user into audio in the target language, and translation of the audio of the target user back to audio in the source language during the call. Further, the invention provides interlacing of the audio of the source user, the target user and the translated audio; in which the listener first hears the original audio from the other participant and then the associated translated audio and the speaker synchronously also hears the translated audio. Further the interlacing provides participants a better understanding of the conversation and conversational flow. Further the method facilitates better translations and clearer transcription, as the audio streams are not overlapped, and further noise and interference are reduced in the audio streams.

### CROSS REFERENCE TO RELATED APPLICATIONS

This application claims priority on U.S. Provisional Patent Application No. 63/003,851, entitled “Real-time call translation system and method”, filed on Apr. 1, 2020, which is incorporated by reference herein in its entirety and for all purposes.

### FIELD OF THE INVENTION

The present invention relates to a real-time call translation system and method. More particularly, the invention relates to a voice translation assistant for translating a source language into a target language and of the target language back to the source language on a call in real-time. Further, the invention provides interlacing of audio of a source user, a target user and the translated audio to coordinate and synchronize overlapping of the audio streams, so that participants can better understand the conversation and conversational process. Further, the interlacing reduces noise and interference to achieve better translation.

### BACKGROUND OF THE INVENTION

With the development of society and globalization, communication is required in business, trade, political, economic, cultural, entertainment and in many other fields. Hence, people from different countries need to communicate frequently and are typically engaged in real-time communication.

Further, with the development of communication technology, the phone has become one of the most important tools for communication. International exchanges are required in many fields and due to which there is an increase in frequency of communications. The main problem during communication is that foreign languages are not understood by all. People are likely to speak different languages across countries. There might be several scenarios that require communication between people who speak different languages. It is not easy to master foreign languages and communicates smoothly with people from other countries. Language barriers are the biggest obstacle in communication between people in different countries/areas.

With the continuing growth of international exchange, there has been a corresponding increase in the demand for translation services, for example, to accommodate business communications between parties who use different languages.

Further, in such scenarios, a human translator who has the knowledge of both the languages may enable effective communication between the two parties. Such human translators are required in many areas of business. But it is not possible every time to have a human translator present.

Further, in many cases a third-party human translator is not allowed, for example, when speaking to a bank or to a doctor a third-party is not allowed to be on the call for privacy and security reasons.

As an alternative to human translators, various efforts have been made for many years to reduce language barriers. Some companies have set themselves the goal of automatically generating a voice output stream in a second language from a voice input stream of a first language.

However, machine translation may have several limitations. One of the limitations of machine translation is that it may not always be as accurate as human translations. Also, the translation process takes some time, and the user experience can be confusing, for example the speakers not waiting for the translated audio to be provided and heard by the other participants before speaking again. Further, speakers cannot be certain if the remote listener has received and fully heard the translated audio.

At present, there are many translation systems on the Internet or on smart terminals such as mobile phones. However, while using these translation systems, there is overlapping in the audio streams and the translated audio, and the audio streams become uncoordinated, noisy, confused, and difficult to understand.

US patents and patent applications U.S. Pat. No. 9,614,969B2, US2015347399A1, U.S. Ser. No. 10/089,305B1, U.S. Pat. No. 8,290,779B2, US20170357639A1, US20090006076A1, US20170286407A1, disclose voice translation during the call in the prior arts.

Further, Pct application WO2008066836A1, WO2014059585A1 etc., discloses voice translation during the call.

But there are issues with these call translation systems. These cannot solve call translation instantaneously; that is, they are unable to perform simultaneous interpretation so that both call sides can talk smoothly knowing the other party has received and heard the translated stream.

It is very inconvenient to use, because in actual applications, it is difficult to accomplish that both call sides can be equipped with equally Personal call terminals. Further, it is difficult for making the counter-party aware and comfortable that they are in a call using a voice translation assistant.

Further, the translated audio quality is not clear and intelligible as it is mixed with original voice and subsequent audio, which is hard to understand for many users. Therefore, it is required to interlace the audio for clarity and understanding as well as the ability to transcribe the call for providing feedback and record.

In light of the foregoing discussion, there is a need for an improved technique to enable translation and transcription of communication between people who speak different languages. The present invention provides a voice translation assistant system and method, in which there is interlacing of the audio of a source user, a target user and the translated audio to coordinate and synchronise overlapping of the audio streams, so that participants can better coordinate, understand the conversation and conversational flow.

### SUMMARY OF THE INVENTION

To solve the above problems, the present invention discloses a real-time in-call translation system and method with interlacing of audio of a source user, a target user and the translated audio to coordinate and synchronise overlapping of the audio streams, so that participants can better coordinate, understand the conversation and conversational flow.

Aspects/embodiments of the present invention provides translation of a call through an application interface includes establishing a call with a first device associated with a source user to a second device associated with a target user, where the source user is speaking a source language and the target user understands and is speaking a target language. The translation process can be activated through a voice command, by pressing a key button, screen touch, visual gesture or by automatic detection of a different language being spoken by the second participant. Further, the method provides automated call translation that allows users to clearly understand that there is an automated process of translation taking place, in which the translated audio is being clearly interlaced with the original audio so that both source and target participants know that translation is taking place and that the translated audio has been provided and heard.

In one aspect of the present invention, the system facilitates the call translation on both-sides, where the application interface is executed on the device of both the source user and the target user.

In one alternate aspect of the present invention, the system facilitates the call translation on one-side, where the application interface is executed on the device associated with the source user for the translation of the audio of the source user into the target language and the audio of the target user back to the source language.

In one alternate aspect of the present invention, the system facilitates the call translation on one-side, where the application interface is executed on the device associated with the target user for the translation of the audio of the source user into the target language and the audio of the target user back to the source language.

In another alternate aspect of the present invention, the system facilitates the call translation in group call or multi-participant conversation, where the application interface is executed on the device associated with each user for the translation of the audio of the source user into the target language.

In another alternate aspect of the present invention, the system facilitates the call translation in group call or multi-participant conversation, where the application interface is executed on the device associated with one participant for the translation of the audio of the source user into the target languages.

In another alternate aspect of the present invention, the system facilitates the call translation through the cloud, where the application interface is executed on a cloud-based server.

In another aspect of the present invention. interlacing of audio of the source user, the target user and translated audio; and then transmitting the translated audio to the target user and further playing the translation back to the source user, where interlacing provides clear indications and coordination of the translated audio and that participants have both heard the translation. Further this interlacing provides for clear transcription as the audio streams are not overlapped, and noise and interferences are reduced in the audio streams.

Further the translated audio is not only provided to the target user but also played back to the source user so that the source user can monitor the translation allowing the source user to pause and wait for a response from the translation process for better interlacing and less confusion between participants, better coordination, clearer understanding of the conversation and conversational flow.

In another aspect of the present invention, the source user initiates the call and can subsequently turn on the translation process through a voice command or via a button feature or set the application interface to automatically detect and select the target language.

In another aspect of the present invention, the target can subsequently turn on the translation process through a voice command or via a button feature or set the application interface to automatically detect and select the target language.

In another aspect of the present invention, the system allows for additional features and functions to help coordinate and ensure that the translation flow and understanding is accurate. Such features include, but are not limited to, repeating a translation, providing an alternative translation or additional translation, providing an in-call dictionary of terms being said and thesaurus. These additional features can be activated using voice commands, key or button clicks, or interface gestures.

In another aspect of the present invention, the translated audio stream is not mixed with the source audio. Therefore, the invention provides the interlacing of the audio of the source user's audio, the target user's audio and the translated audio. The interlacing means that the audio streams are synchronise and not overlapping, so noise and interference are reduced, which allows for better translation. Further the interlacing facilitates better and clearer transcription of the dialogue to text.

In another aspect, the present invention provides a computer-implemented method of performing in-call translation through an application interface executed on a device of at least one user, the method includes calling through the application interface on a first device associated with a source user to a second device associated with a target user and establishing a call session, where the source user is speaking a source language and the target user is speaking a target language; selecting the language of the target user to initiate translation of an audio of the source user in the call; performing translation of the audio of the source user into the target language; analysing translated audio data of the call; determining an action on the call session based on the analysis, wherein the action includes at least pausing the call in between, repeating a sentence of the translated audio data; interlacing the audio of the source user, the target user and the translated audio during the call; and transmitting the translated audio to the target user and playing the translated audio back to the source user.

The present invention performs translation during the call, where the translation is further based on context of the conversation which improves the accuracy of the translation. Context includes but is not limited to an in-call dictionary, subject area, nature of the conversation such as banking, booking a restaurant etc., analysis of previous conversations with the participant and personal information such as calendars, bookings, and email history.

Further, the present invention provides translation for a multi-user call or a conference call by performing the translation of audio of the source user into the target languages of each participant, and the translation of audio of each participant into the source language and other languages, in which the speaker hears the translated audio of one of the target users, while each target user hears the audio of the source user and then the translated audio of the source user into their language.

Further, the invention provides for improved transcribing and recording to aid documentation of the call session for security and recording purposes.

Further, the method can keep recordings of conversations or parties along with their transcription which can be used to provide additional information to the context engine and for improvements in the training data for future call sessions.

The summary of the invention is not intended to limit the key features and essential technical features of the claimed invention and is not intended to limit the scope of protection of the claimed embodiments.

### BRIEF DESCRIPTION OF THE DRAWINGS

The object of the invention may be understood in more detail and particular description of the invention briefly summarized above by reference to certain embodiments thereof which are illustrated in the appended drawings, which drawings form a part of this specification. It is to be noted, however, that the appended drawings illustrate preferred embodiments of the invention and are therefore not to be considered limiting of its scope, for the invention may admit to other equally effective equivalent embodiments.

FIG. 1a is a schematic illustration of a call translation system in accordance with an embodiment of the present invention;

FIG. 1b is a schematic illustration of a call translation system further in accordance with an embodiment of the present invention;

FIG. 1c is a schematic illustration of a multi-user call translation system further in accordance with an embodiment of the present invention;

FIG. 2 is another schematic illustration of a call translation system on the cloud-based server in accordance with another embodiment of the present invention;

FIG. 3 is a schematic illustration of detailed views of a communication device;

FIG. 4. is a schematic block-diagram of server system for end-to-end translation, in accordance with embodiments of the present invention;

FIG. 5 illustrates an exemplary translation engine configured with a communication interface of the call translation system in accordance with embodiments of the present invention;

FIG. 6 illustrates an exemplary context-based translation of the call translation system in accordance with embodiments of the present invention;

FIG. 7 is a flowchart for a method of facilitating communication and translation in real-time between users as part of a call in accordance with embodiments of the present invention; and

FIG. 8 is an exemplary method of interlacing of an audio of the source user, the target user and a translated audio in accordance with embodiments of the present invention.

### DETAILED DESCRIPTION OF THE INVENTION

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a”, “an” and “the” are intended to include the plural forms as well, unless the context clearly indicates otherwise.

The term “source user” as used herein refers to a user who is starting the call i.e. caller or dialler.

The term “target user” as used herein refers to a user who is recipient of the call i.e. receiver or recipient.

Further, in the present invention, when an audio/a voice is converted into another language from a language, the language originally is thus referred to as “source language”, and the language exported is then referred to as “target language”. In alternatives, the language of the source user is “source language” and the language of the target user is “target language”.

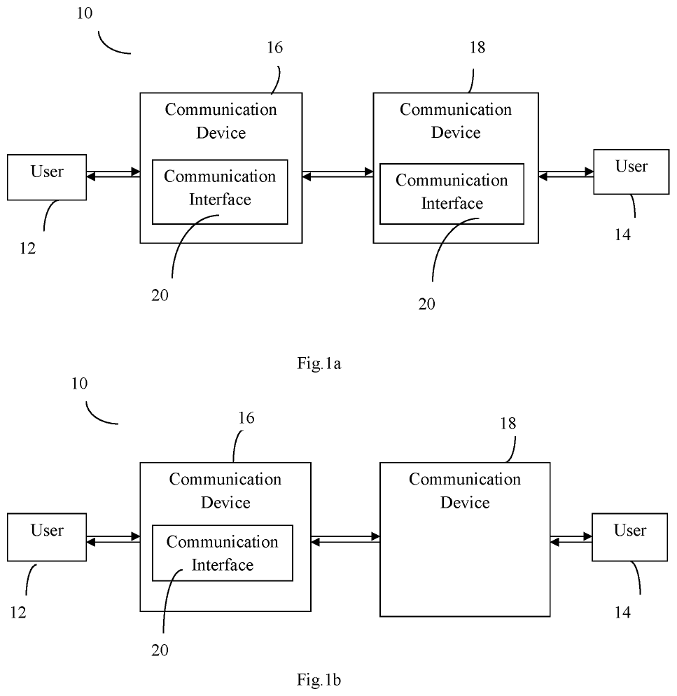

As described herein with several embodiments, the present invention provides a real-time call translation system and method. Now referring to figures the present invention provides a call translation system 10 as illustrated in the FIG. 1a, FIG. 1b and FIG. 1c. In one embodiment as illustrated in FIG. 1a and FIG. 1b, the system 10 operates on a communication device 16 by a first user 12 (also referred as source user); the communication device 16 is running an application. The application provides a communication interface 20 that facilitates communication and real-time call translation configured with a translation program. The application includes the communication interface 20 executed by a program on a local processor on the communication device 16 which allows the first user 12 to establish a call (audio calls or video calls) to a communication device 18 associated with a second user 14 (also referred as target user) over a network which is a packet-based network in this embodiment but which may not be packet-based in other embodiments.

In other words, the system 10 includes the interface 20 to facilitate communication and translation on the communication devices 16, 18 associated with the users. In one embodiment, the communication device 16, 18 is a mobile phone e.g., Smartphone, a personal computer, tablet, smart sunglass, smart band, or other embedded device. The application includes the communication interface 20, in which the source user can make a call to the target user who is on a standard phone with no special capabilities.

As shown in FIG. 1a, the second user 14 who has a communication device 18 that executes the communication interface 20 in order to communicate in the same way that the first user 12 executes the application to facilitate communication and translation on over the network. In some embodiments, the communication interface 20 can be on the communication device of both the source user and the target user, so that any of them can initiate real-time call translation.

In some embodiments, the system 10 facilitates the call translation on both-sides, where the communication interface 20 is executed on the device 16, 18 of both the source user 12 and the target user 14.

In some embodiments, the system 10 facilitates the call translation on one-side, where the communication interface 20 is executed on the device 16 associated with the source user 12 for the translation of the audio of the source user 12 into the target language as shown in FIG. 1b. The system 10 provides an automated call translation that allows parties to clearly understand that there is an automated process of the translation, in which the translated audio is transferred to the target user. Hence, there may be no application installed on the target user's device. So long as it is present on the source device, the translation, interlacing and coordination is performed.

In some embodiments, the system 10 facilitates the call translation in group call or multi-participants conversation, where the communication interface 10 is executed on the communication device associated with each user for the translation into the target language. As shown in FIG. 1c, communication events between first user 12, second user 12 and third user 22 can be established using the communication interface 20 in various ways. For instance, a call can be established by first user instigating a call invitation to the second user. Alternatively, a call can be established by first user 12 in the system 10 with the second user 14 and third user 224 as participants, the call being a multiparty or multi-participant. In some embodiments for illustrative purpose only first user 12, second user 14 and third user 22 are shown in FIG. 1c but there can be more than three users without limiting the scope of the invention.

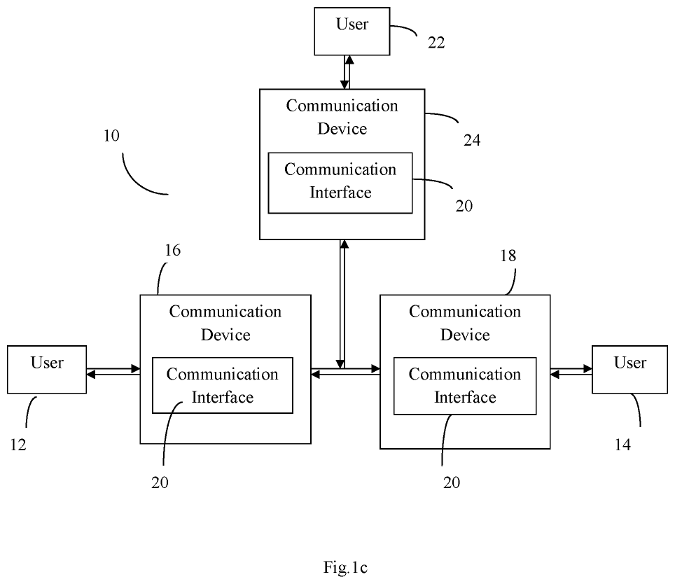

In some embodiments as shown in FIG. 2, the system 10 facilitates the call translation through cloud, where the communication interface 20 is executed on a cloud-based server.

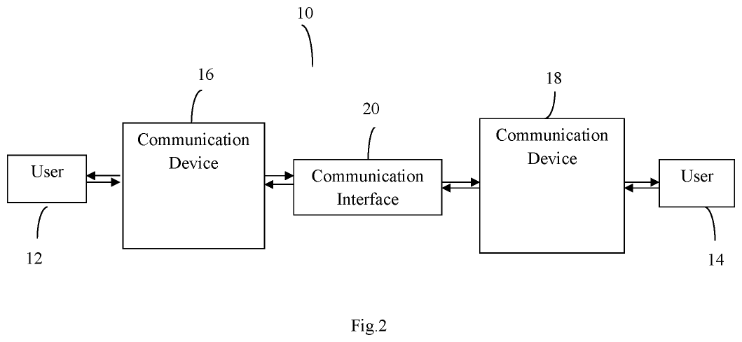

FIG. 3 illustrates an exemplary detailed view of the communication device 16, 18, 24 associated with the user on which the communication interface 20 is executed. As shown in FIG. 3, the communication device comprises at least one processor 31, further the processor is connected with a memory 32 for storing data and performing translation with the communication interface 20. Further includes a key button (Keypad) 33 for calling the target user or selecting a command. Further an input audio device 34 (e.g. one or more microphones) and output audio device 35 (e.g. one or more speakers) are connected to the processor 31. The processor 31 is connected to a network 36 for communicating by the system 10.

The communication device 16, 18, 24 may be, for example, a mobile phone (e.g. Smartphone), a personal computer, tablet, smart sunglass, smart-band or other embedded device able to communicate over the network 36.

A control server 37 is operating the interface 20 for performing translation during call. The control server 37 is configured with the interface 20 for the communication along with the translation process. While the call may be a simple telephone call on one or both ends of a two-party call/more than two parties, the descriptions hereinafter will reference an embodiment in which at least one end of the call is accomplished using VOIP.

The control server 37 may accommodate two-party or multi-party calls and may be scaled to accommodate any number of users. Multiple users may participate in a communication, as in a telephone conference call conducted simultaneously in multiple languages.

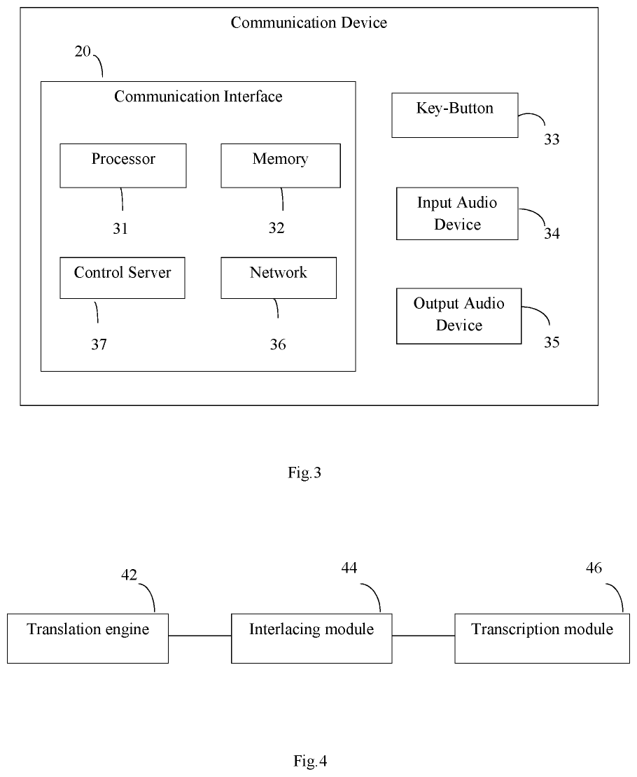

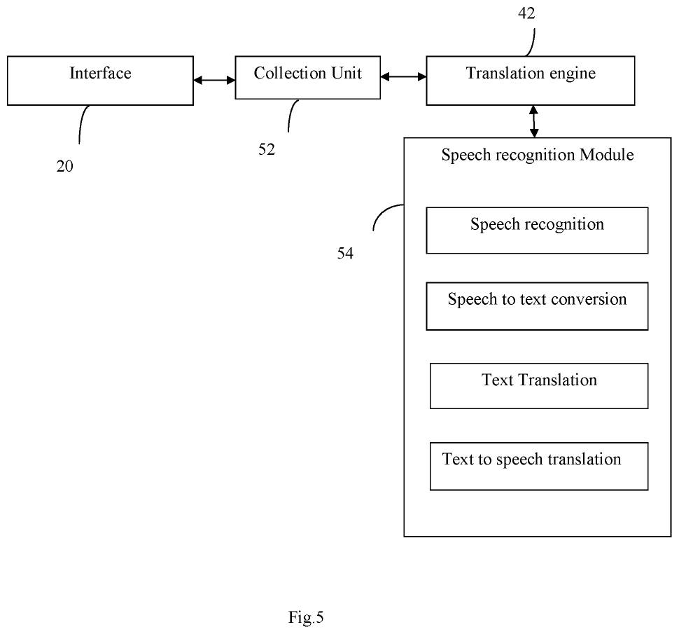

Turning now to FIG. 4 and FIG. 5, therein is depicted one exemplary embodiment of an end-to-end translation of the present invention. The first communication device 16 is operated by the first user to a call employing a first language, a second communication device 18 that is operated by a second user to the call employing a second language. The system 10 incorporates a translation engine 42 to assist in real-time or near-real-time translation or to provide further accuracy and enhancements to the automated translation processing. Further, the system 10 includes interlacing module 44 for interlacing audio of the users and the translated audio to coordinate and synchronize the audio streams prevent overlapping, and further noise and interference are reduced. The system further includes a transcription module 46 that provides transcribing and recording to aid documentation of the call session for security purposes and further for retaining conversations for subsequent analysis including context adaptations and data for improving model training.

In a preferred embodiment, the invention provides an interface 20 for establishing a call with the first communication device 16 associated with the source user to the second communication device 18 associated with the target user, where the source user speaking a source language and the target user speaking a target language, then requesting to select the target language to initiate the translation of the source language of the audio of the source user in the call by a voice command or pressing a key button or screen touch or visual gesture on the communication interface 20, performing the translation of the audio of the source user into the target language, analyzing at least one of translated audio call data; interlacing the audio of the source user, the target user and the translated audio; and transmitting the translated audio to the target user and simultaneously played back the translated audio to the source user.

As shown in FIG. 5, the source user initiates the call and can turn on the translation through a voice command or pressing a key button or screen touch or visual gesture to automate the translation. As discussed above, the interface 20 is configured with the translation engine 42. When the translation command is received from the user, the system starts collecting the speech of a source user through a voice collection unit 52; respectively importing the collected voice into the speech recognition unit 54 through the processor 31 to obtain confidence degrees of the voice corresponding to different alternative languages, and determining a source language used by the source user according to the confidence degrees and a preset determination rule, and converting the voice from the source language into a target language through the processor 31, then transferring the translated language to target user and playing back to the source user via the sound playing device.

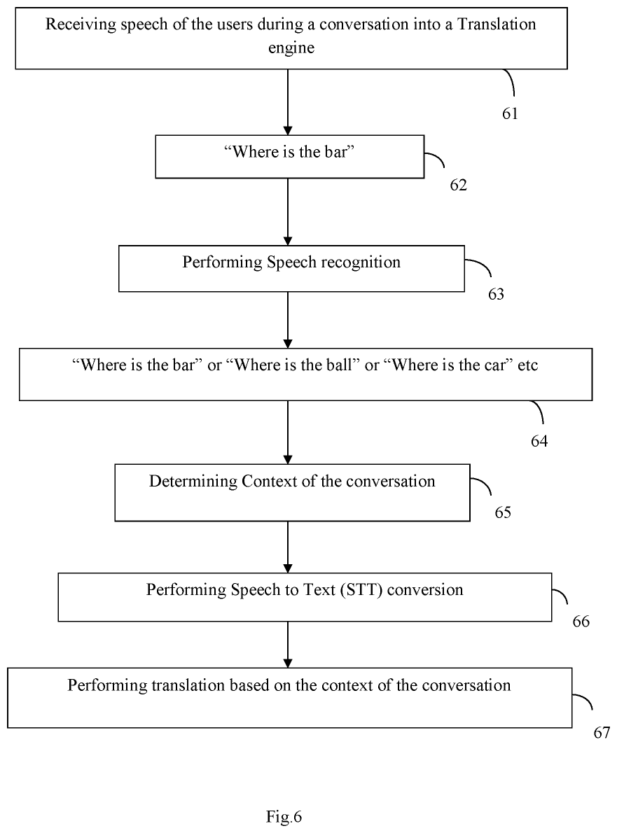

As discussed above, the translation engine 42 includes a speech recognition unit 54 that can accept speech, performing Speech to Text (STT) conversion, then performing Text Translation form source language to target language and then Text to Speech translation. In some embodiment context-based Speech to Text (STT) and context-based translation improves translation while giving possible alternative sentences. As shown in FIG. 6 is an exemplary embodiment described herein with various steps includes receiving speech of the users during a conversation into a Translation engine 61, for example “Where is the bar” 62, performing speech recognition 63 that could be heard and transcribed as “Where is the bar” or “Where is the ball” or “Where is the car” etc. 64, further determining context of the conversation 65 then performing Speech to Text (STT) conversion 66 and performing adaptation and translation based on the context of the conversation 67 that provides confidence and improves the accuracy of the translation.

As discussed herein, in some embodiments, the translation engine 42 is configured with the speech recognition unit 54; the speech recognition unit 54 performs a speech recognition procedure on the source audio. The speech recognition procedure is configured for recognizing the source language. Specifically, the speech recognition procedure detects particular patterns in the call audio which it matches to known speech patterns of the source language in order to generate an alternative representation of that speech. On the request of the source user, the system performs translation of the source language into the target language. The translation is performed ‘substantially-live e.g. on a per-sentence (or few sentences), per detected segment, on pause, or per-word (or few words). In one embodiment, the translated audio is not only sent to the target user but also played back to the source user. In a normal call the source audio is not played back as it confuses the speaker as it is an echo. But in this case, the translated audio is played back to the source user.

Further, in another embodiment, the present invention provides monitoring of the translation that allows the user to pause and wait for a response from the translation process.

In another embodiment, the present invention provides interlacing of the source audio, target audio and translated audio, that allows the target user to understand that there is a translation process, and they should wait until both source audio and translated audio are played. In an exemplary embodiment, some audio clues, such as beep tones are activated using the voice command or key button, which makes the users aware of the gap and coordination between the source audio and the translated audio.

In another embodiment of the present invention, the translation assistance can be turned on during the call (i.e. does not need to be turned on prior to making a call).

In another embodiment, the source user initiates the call and can subsequently turn on the translation through a voice command or via a key button feature or smart triggers or set the function to automatic detect and translate to the target language. The user can provide the commands for selecting a language for the translation, for pausing the call in between or repeating the sentence etc. For example, Polyglottel™ please pause the call for 10 second; Polyglottel™ please translate audio into Chinese language, etc.

Further, in another embodiment, the original audio of the source user is sent to the target user and vice-versa.

In another embodiment, the system 10 provides an ability to change the sound levels of both the source audio and the translated audio. This is done through the interface 20 (Graphical user interface—GUI) of the App on the device or through voice commands during the call. For example, it provides an interactive interface for increasing or decreasing the sound of the source audio and the translated audio as per the user's convenience.

The invention provides the audio stream in high quality that is the audio stream is not mixed with the source audio and the translated audio as prior art methods are doing.

Unlike other voice apps, this system allows both source and target user to hear the translation of their own audio input. This has the benefit of keeping the rhythm of natural speech within the context of the dialogue.

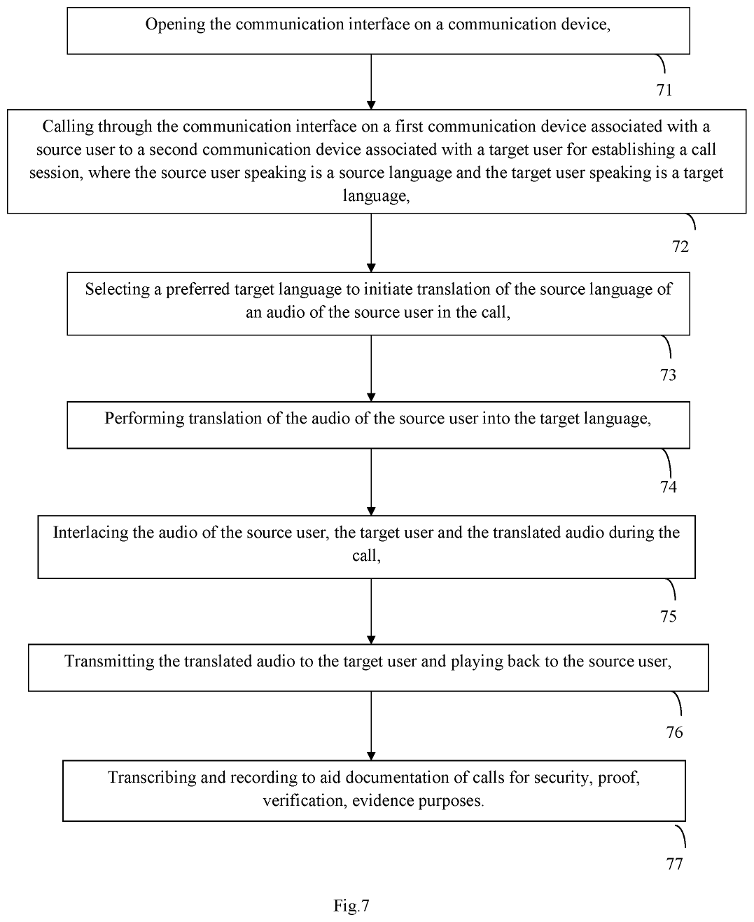

A method of facilitating communication and translation in real-time between users during an audio or video call will be described herewith reference to FIG. 7. FIG. 7 describes the in-call translation procedure from source language to target language only for simplicity; it will be appreciated that a separate and equivalent process can be performed to translate simultaneously in the same call.

In another embodiment, the method of facilitating communication and translation in real-time between users is described herein with various steps. The method includes at step 71, opening a communication interface 20 which is executed on a communication device; at step 72, calling through the communication interface 20 on a first communication device associated with a source user to a second communication device associated with a target user for establishing a call session, where the source user speaking a source language and the target user speaking a target language; at step 73, selecting the target language to initiate translation of the source language of an audio of the source user in the call through an interactive voice command or via key button or screen touch or visual gesture on the interface; at step 74, performing translation of the audio of the source user into the target language; at step 75, interlacing the audio of the source user, the target user and the translated audio during the call; at step 76, transmitting the translated audio to the target user and playing the translated audio back to the source user; and at step 77, transcribing and recording to aid documentation of calls for including but not limited to security, proof, verification, evidence purposes, analysis and collection of data for training.

In some embodiments, the interlacing function allows a pause recognition sound to be inserted to allow source user and target user to recognize start and end of the translation and/or output by both the user.

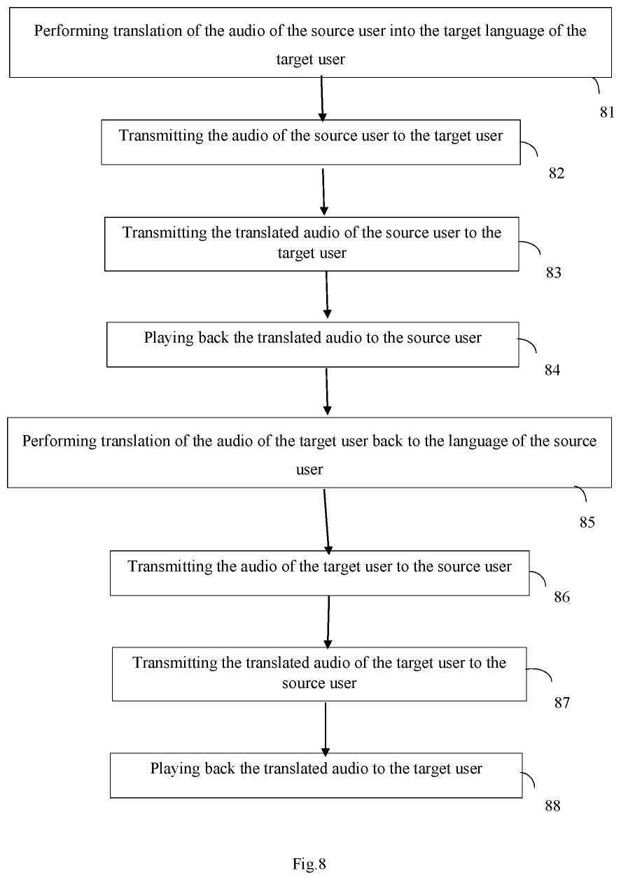

As shown in FIG. 8, further in another embodiment provides interlacing of the audio between source user and target user and that of the translated audio which allows for clear transcription of the audio conversation to text. The method includes at step 81, after performing translation of the audio of the source user into the target language of the target user; at step 82, transmitting the audio of the source user to the target user; at step 83, transmitting the translated audio of the source user to the target user; at step 84, playing back the translated audio to the source user; at step 85, after performing translation of the audio of the target user back to the language of the source user; at step 86, transmitting the audio of the target user to the source user; at step 87, transmitting the translated audio of the target user to the source user; and at step 88, playing back the translated audio to the target user. Hence the interlacing of the audio between the source user, the target user, and the translated audio means that the audio streams are coordinated, and not overlapping, so participants can better understand the conversation and conversational process. Further, the interlacing reduces noise and interference to achieve better translation.

One advantage, the present invention provides a call terminal (communication interface 20) for real-time original voice translation during the call, and the voice translated is sent to the users in which the sense of reality is stronger, the accuracy and quality is high.

One more advantage, the translation is performed by the interface on the communication device of the source user, therefore this system 10 does not require any additional equipment or process, as long as the side of the caller (source user) is equipped with the call terminal, the receiver (target user) can be equipped with a regular conversation terminal for example speaking to a bank representative or doctor or legal persons.

Another advantage, the invention provides interlacing the audio of the source user, the target user, and the translated audio during the call, which is beneficial for communication in which a normal third-party translator is not allowed, for example speaking to a bank representative or doctor or legal person.

Another advantage, the present invention provides interlacing of the audio for clear transcription of the conversation to text. Therefore, the interlacing of the audio between the source user and the target user means that the audio streams are not overlapping, and so noise and interference are reduced, which allows for better translation and transcription.

In one more advantage, the present invention provides call translation on the target user's side. The target user may provide this a valid service for translating audio of the call from users. For example, when talking to a Bank or a Doctor or a legal person in which confidential information cannot be shared to 3^{rd} party human translators.

In another advantage, the present invention provides transcribing and recording of the audio of user and the translated audio aid documentation of calls for security purposes to meet the legal and security requirement of, but not limited to, financial, medical, government and military applications.

In another advantage, the present invention provides better audio translation and the users are aware an automated translation is taking place.

In another advantage, the present invention provides translation during the call, where the translation is further based on contexts of the conversation, accordingly the translation is performed which improves the accuracy of the translation.

The system implementations of the described technology, in which the application interface 20 is capable of executing a program to execute the translation, the interface 20 is connected with a network 36, control server 37 and a computer system capable of executing a computer program to execute the translation. Further, data and program files may be input to the computer system, which reads the files and executes the programs therein. Some of the elements of a general-purpose computer system are a processor having an input/output (I/O) section, a Central Processing Unit (CPU), translation program, and a memory.

The described technology is optionally implemented in software devices loaded in memory, stored in a database, and/or communicated via a wired or wireless network link, thereby transforming the computer system into a special purpose machine for implementing the described operations.

The embodiments of the invention described herein are implemented as logical steps in one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

1. A computer-implemented method of performing in-call translation through a communication interface, the method comprising:
calling through a first device associated with a source user to a second device associated with a target user and establishing a call session, where the source user is speaking a source language and the target user is speaking a target language;
selecting a target language of the target user to initiate translation of an audio of the source user during the call;
performing translation of the audio of the source user into the selected target language;
performing translation of an audio of the target user back to the language of the source user;
analysing translated audio data of the call;
interlacing the audio of the source user, the target user and the translated audio of the call; and
transmitting the translated audio to the target user and playing back the translated audio to the source user.

2. The method of claim 1, wherein the in-call translation processing is executed on one or both devices, where the communication interface is executed on the first device associated with the source user and/or the second device associated with the target user, for the translation of the audio of the source user into the target language and the translation of the audio of the target user into the source language.

3. The method of claim 1, wherein the in-call translation is preformed within the communications infrastructure, such as, but not limited to, telephony network, IP network, cloud server or other connectivity.

4. The method of claim 1, wherein a voice command, a key button, a screen touch or visual gesture, automatic language detection are used, but not limited to, selecting the target language, pausing the call, repeating a sentence of the translated audio data, terminating the in-call translation.

5. The method of claim 1, where the target user first hears the original untranslated audio as it is spoken and then hears the translated audio.

6. The method of claim 1, wherein the source user pauses after speaking to hear the translated audio of their utterance, synchronously or largely synchronously with the target user.

7. The method of claim 1, wherein further a context of conversations during the call is used in the analysis and adaptation of the Speech to Text (STT) process that increases confidence and improves accuracy of the translation.

8. The method of claim 1, wherein the interlacing of the source audio, the target audio and the translated audio allows the target user to understand and know that the translation is being performed and alerts the target user to wait for both the source audio and the translated audio to be heard.

9. The method of claim 1, wherein the interlacing coordinates and synchronises overlapping between the source audio, the target audio with the translated audio, and further noise and interference are reduced which provides for improved transcribing and recording to aid documentation of the call session, as used in, but not limited to, security, proof, verification, evidence purposes, analysis, and collection of data for training.

10. A computer-implemented in-call translation system, comprising:
a memory;
a processor; and
a communication interface;
where the processor is coupled to the memory, the processor is configured with the communication interface to:
establish a call with a first device associated with a source user to a second device associated with a target user, where the source user speaks a source language and the target user speaks a target language;
select the target language to initiate translation process of an audio of the source user's audio during the call;
perform the translation of the audio of the source user into the target language;
analyse at least one part of the translated audio data;
interlace the audio of the source user, the target user and the translated audio; and
transmit the translated audio to the target user and simultaneously play back the translated audio to the source user.

11. The system of claim 10, wherein a device is any communications device, such as, but not limited to, Dial Phones, Mobile phones, Smartphones, Smart glasses, Tablets, Smart bands, Wearables or Human Augmentations.

12. The system of claim 10, wherein the in-call translation is executed on one-side or both-sides, where the communication interface is executed on either the first device associated with the source user and/or the second device associated with the target user, for the translation of the audio of the source user into the target language and the translation of the audio of the target user into the source language.

13. The system of claim 10, wherein the in-call translation is preformed within the network communication infrastructure or a cloud server or connectivity.

14. The system of claim 10, where the target user first hears the original untranslated audio as it is spoken and then hears the translated audio.

15. The system of claim 10, wherein the source user pauses after speaking to hear the translated audio of their utterance, synchronously or largely synchronously with the target user.

16. The system of claim 10, wherein the interlacing and feedback of the source audio, the target audio and the translated audio allows the target user to understand that the translation is being performed and alerts the target user to wait for both the source audio and the translated audio to be heard.

17. The system of claim 10, wherein further a context of conversations during the in-call is analysed for a Speech to Text (STT) perspective that increases confidence and improves accuracy of the translation.

18. The system of claim 10, wherein the interlacing coordinates and synchronises overlapping between the source audio, the target audio with the translated audio, and further noise and interference are reduced, which provides transcribing and recording to aid documentation of the call session for, but not limited to, security, proof, verification, evidence purposes, analysis, and collection of data for training.

19. The system of claim 10, wherein further provides a valid service for translating audio of the call from users such as including, but not limited to, legal, banking, and medical where a third party is not allowed on the call for privacy reasons.
